(19) United States
(12) Patent Application Publication
(10) Pub. No.: US 2021/0136884 A1
(43) Pub. Date: May 6, 2021

(54) MICROWAVE RANGE AND RADIATION MODULE THEREOF

(71) Applicant: SP RANGE LTD., Seoul (KR)

(72) Inventor: Soo Yong PARK, Seoul (KR)

(73) Assignee: SP RANGE LTD., Seoul (KR)

(21) Appl. No.: 16/334,549

(22) PCT Filed: Sep. 11, 2017
(86) PCT No.: PCT/KR2017/009923

§ 371 Date: Mar. 19, 2019

(30) Foreign Application Priority Data
Sep. 19, 2016 (KR) 10-2016-0119063
Jul. 6, 2017 (KR) 10-2017-0086041

(51) Int. Cl. H05B 6/70; H05B 6/72

(52) U.S. Cl. CPC H05B 6/708; H05B 6/72

(57) ABSTRACT

Provided are a microwave range, which uniformly radiates microwaves from an upper part of a cooking chamber in order to cook food, and a radiation module thereof. The microwave range includes a cooking chamber, a magnetron that radiates microwaves through an antenna, and a radiation module including a waveguide that introduces the microwaves into an upper part of a rectangular upper surface of a cooking chamber from the antenna and provides a propagation path along which the introduced microwaves are horizontally guided along sides of the upper part of the upper surface of the cooking chamber, and radiating the microwaves to the cooking chamber through two or more paired slot antennas formed on a bottom surface of the waveguide.

### TECHNICAL FIELD

The present disclosure relates to a microwave range and a radiation module thereof, and more particularly, to a microwave range, which uniformly radiates microwaves from an upper part of a cooking chamber in order to cook food, and a radiation module thereof.

### BACKGROUND ART

A microwave range is configured to radiate a microwave into a cooking chamber in order to cook food.

A general microwave range includes a magnetron that generates microwaves in a machine room on sides of a cooking chamber, and is configured to radiate the microwaves to the cooking chamber through sidewalls of the cooking chamber. The microwave range, which radiates the microwaves to the cooking chamber through the sidewall of the cooking chamber as described above, is defined as a side emission type microwave range.

Since the side emission type microwave range radiates the microwaves through the sidewalls of the cooking chamber, it is necessary to rotate food in the cooking chamber in order to uniformly heat the food. Therefore, the side emission type microwave range requires parts for rotating the food, and to this end, parts such as a turntable, rollers, and a motor are provided in the cooking chamber and a lower space.

The side emission type microwave range has a complicated configuration due to the auxiliary parts such as the turntable, the rollers, and the motor configured for rotating food. Particularly, the motor is one of the main causes of failures occurring in the microwave range.

Furthermore, in order to provide the motor and the rollers, a separate space needs to be provided in the lower part of the cooking chamber. Therefore, in the side emission type microwave range, it is not difficult to reduce a volume due to a space for the aforementioned auxiliary parts.

Furthermore, the turntable occupies a part of an internal space of the cooking chamber. Therefore, in the side emission type microwave range, the space of the cooking chamber is small.

Furthermore, the side emission type microwave range heats food by using the microwaves radiated from a limited area of one sidewall of the cooking chamber. Therefore, in the side emission type microwave range, it is difficult to uniformly heat the food even though the food is rotated.

Due to such a reason, the side emission type microwave range is configured to cook food while rotating the turntable. The cooking chamber is generally configured to have a rectangular space. However, the turntable is manufactured in a circular shape rotatable in the rectangular space. Therefore, in the internal space of the cooking chamber, only a part of the space where the turntable is rotatable is used for cooking and the remaining space is wasted.

Due to such a reason, it is difficult to utilize a rectangular container having a length larger than the rotation diameter of the turntable. Therefore, in the side emission type microwave range, a container available for cooking is limited in size and shape.

### CITATION LIST

Patent Literature 1: Korean Patent Application Laid-Open No. 10-2008-0040380 (Publication Date: May 8, 2008: Microwave oven with device for rotating tray)

Patent Literature 2: Korean Patent Application Laid-Open No. 10-2008-0040381 (Publication Date: May 8, 2008: Microwave oven with device for dispensing microwave)

### DISCLOSURE

### Technical Problem

Various embodiments are directed to provide a microwave range capable of cooking food by radiating microwaves from an upper part to a lower part of a cooking chamber.

Furthermore, various embodiments are directed to a radiation module of a microwave range, which guides microwaves radiated from a magnetron to an upper part of a cooking chamber and radiates the microwaves from the upper part to a lower part of the cooking chamber.

Furthermore, various embodiments are directed to provide a microwave range, in which microwaves propagate in a horizontal spiral shape in an upper part of a cooking chamber and are radiated to the cooking chamber through paired slot antennas, so that food can be uniformly heated, and a radiation module thereof.

Furthermore, various embodiments are directed to provide a microwave range, in which it is possible to remove reflected waves, which are generated by a height difference of a waveguide or deflection of a propagation direction of microwaves when the microwaves go straight or are bent, by destructive interference, and a radiation module thereof.

Furthermore, various embodiments are directed to removing reflected waves generated from two slot antennas by destructive interference by using paired slot antennas, to spatially uniformizing microwaves radiated into a cooking chamber by using a plurality of paired slot antennas, and to improving a heating effect of food by allowing microwaves radiated from the two slot antennas to be temporally uniformized by a phase difference of ¼ cycle.

### Technical Solution

In an embodiment, a microwave range includes a cooking chamber; a magnetron configured to radiate microwaves through an antenna; and a radiation module including a waveguide that introduces the microwaves into an upper part of a rectangular upper surface of a cooking chamber from the antenna and provides a propagation path along which the introduced microwaves are horizontally guided along sides of the upper part of the upper surface of the cooking chamber, and configured to radiate the microwaves to the cooking chamber through two or more paired slot antennas formed on a bottom surface of the waveguide, wherein each of the paired slot antennas includes two slot antennas perforated along major axes, and the two slot antennas are formed such that a distance differs in the same direction with respect to a center line of a width of the waveguide, the major axes are parallel to a propagation direction of the microwave, and centers of the major axes are formed to be spaced apart from each other by a distance corresponding to ¼ of a wavelength of the microwaves in the waveguide.

In an embodiment, a radiation module of a microwave range includes a waveguide configured to introduce microwaves radiated through an antenna of a magnetron into an upper part of a rectangular upper surface of a cooking chamber, to horizontally guide the microwaves along sides of the upper surface in the upper part of the upper surface, and to radiate the microwaves to the cooking chamber through two or more paired slot antennas formed on a bottom surface, wherein the waveguide includes: two or more straight wave guides corresponding to sides of the rectangular upper surface of the cooking chamber and configured to straightly guide the microwaves; and bends configured to connect the straight wave guides to each other and to guide the microwaves at a right angle in a first direction, wherein one or more paired slot antennas are formed in each of the straight wave guides, each of the paired slot antennas includes two slot antennas perforated along major axes, and the two slot antennas are formed such that a distance differs in the same direction with respect to a center line of a width of the waveguide, the major axes are parallel to a propagation direction of the microwave, and centers of the major axes are formed to be spaced apart from each other by a distance corresponding to ¼ of a wavelength of the microwaves in the waveguide.

### Advantageous Effects

According to the present invention, microwaves are radiated from an upper part of the cooking chamber, so that it is possible to cook food in the cooking chamber.

According to the present invention, when microwaves are radiated to cook food, it is not necessary to rotate the food, so that it is possible to reduce parts such as a turntable, a motor, and a roller required for rotating the food and to reduce a space for storing or providing such parts.

Furthermore, according to the present invention, since the turntable is not provided in the cooking chamber, it is possible to efficiently utilize a space of the cooking chamber 10 and to cook food by putting containers having various sizes and shapes into the cooking chamber.

Furthermore, according to the present invention, the microwaves spirally propagate in the upper part of the cooking chamber and are radiated into the cooking chamber, so that it is possible to uniformly heat food.

Furthermore, the present invention has an advantage in that reflected waves which may be generated when the microwaves go straight or are bent are cancelled, so that it is possible to reduce the influence on the microwaves due to the reflected waves.

Furthermore, according to the present invention, it is possible to radiate the spatially uniform microwaves by radiating the microwaves into the cooking chamber by using a plurality of paired slot antennas, and to obtain a temporally uniform heating effect by a phase difference of the microwaves radiated from two slot antennas.

### BRIEF DESCRIPTION OF DRAWINGS

FIG. 1 is a perspective view exemplifying an embodiment of a microwave range of the present invention.

FIG. 2 is a perspective view exemplifying a configuration of a radiation module and a magnetron applied to the embodiment of FIG. 1.

FIG. 3 is a plan view of the radiation module of FIG. 2.

FIG. 4 is a plan view of a base of the radiation module in FIG. 2 from which an upper cover has been removed.

FIG. 5 is a plan view exemplifying a waveguide on the base.

FIG. 6 is a sectional view taken along line A-A of FIG. 3.

FIG. 7 is a sectional view exemplifying a connection state among a straight wave guide SL3, a bend BD3, and a straight wave guide SL4.

FIG. 8 is a sectional view exemplifying a connection state among the straight wave guide SL4, a bend BD4, and a straight wave guide SL5.

FIG. 9 is a sectional view of another embodiment employing the inclined straight wave guide SL5 in FIG. 8.

FIG. 10 is a plan view exemplifying a paired slot antenna.

FIG. 11 and FIG. 12 are plan views for explaining a modification example of a slot antenna.

FIG. 13 is a sectional view of a waveguide exemplifying that a dielectric is employed for a slot antenna.

FIG. 14 is a plan view for explaining an arrangement of paired slot antennas of the last straight wave guide SL5.

FIG. 15 is a plan view exemplifying formation of an electric field by microwaves.

FIG. 16 and FIG. 17 are plan views exemplifying other embodiments of the prevent invention.

### MODE FOR DISCLOSURE

Hereinafter, preferred embodiments of the present invention will be described in detail with reference to the accompanying drawings. The terms used in this specification and claims are not limited to typical or dictionary definitions, but should be interpreted as meanings and concepts which coincide with the technical idea of the present invention.

Embodiments described in this specification and configurations illustrated in the drawings are preferred embodiments of the present invention, and do not represent the entire technical idea of the present invention. Thus, various equivalents and modifications capable of replacing the embodiments and configurations may be provided at the time of filing the present application.

The present invention includes a technical characteristic that a structure is disclosed in which microwaves are guided to an upper part of a cooking chamber and are radiated to the cooking chamber.

Furthermore, the present invention includes a technical characteristic that it is possible to reduce reflected waves by using paired slot antennas, to achieve temporal uniformization of microwaves radiated into a cooking chamber, and to achieve spatial uniformization of the microwaves by using a plurality of paired slot antennas for microwave radiation.

Furthermore, the present invention includes a technical characteristic including paired slot antennas having an inverted phase of microwaves radiated into a cooking chamber, in order to prevent cancellation of the microwaves.

Meanwhile, it is generally to be located opposite to each other with respect to a center line of an array antenna and to have an interval of ½ of the wavelength of microwaves. However, paired slot antennas of the present invention have a structure different from that of the array antenna. The paired slot antennas of the present invention are disposed in the same direction with respect to an antenna center line, and two slot antennas are configured to have an interval of ¼ of the wavelength of the microwaves in a waveguide. According to such an arrangement, it is possible to effectively remove reflected waves generated by the slot antennas.

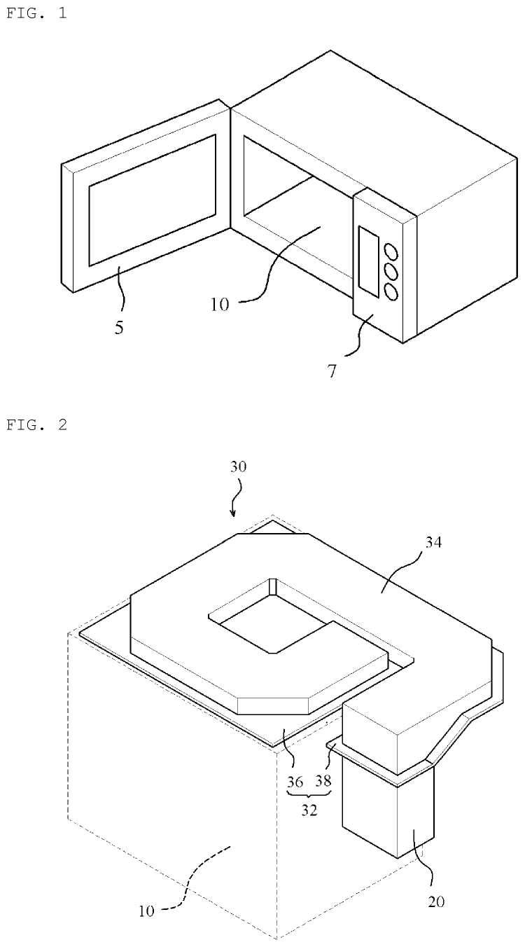

An embodiment of the present invention may be disclosed as illustrated in FIG. 1.

A microwave range may include a door 5 that is hinged to one side of the front and openable and closable by rotation, and a control panel 7 provided with manipulation buttons and a display capable of displaying an operation state.

The microwave range includes a cooking chamber 10 openable and closable by the door 5. The cooking chamber 10 has a rectangular internal space for cooking stored food.

The inside of the microwave range may be divided into the cooking chamber 10 and a machine room (not illustrated), and the machine room may be formed in one side space of the cooking chamber 10, that is, a space behind the control panel 7. The machine room is a space that is covered by a case together with the cooking chamber 10, and is used to mount parts such as a magnetron 20 to be described later, a part of a radiation module 30 and a cover 34 to be described later, and a printed circuit board and an interconnection of the control panel 7.

The magnetron 20 is a part that generates microwaves with a preset frequency and radiates the microwaves through an antenna.

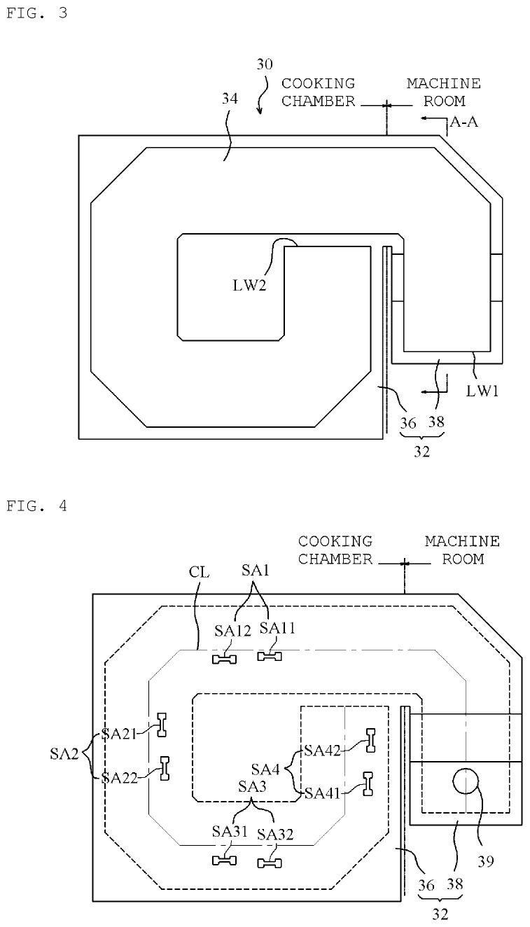

The embodiment of the present invention includes the radiation module 30 provided on an upper surface of the cooking chamber 10. The radiation module 30 has a structure of introducing the microwaves of the magnetron 20 to an upper part of the cooking chamber 10 and radiating the introduced microwaves to the cooking chamber 10. A detailed configuration of the radiation module will be described later with reference to FIG. 2 to FIG. 4.

According to the embodiment of the present invention, it is possible to heat and cook food by using the microwaves uniformly radiated from the upper surface of the cooking chamber 10.

According to the embodiment of the present invention, since the microwaves are radiated from the upper part of the cooking chamber 10, it is possible to heat and cook food without rotating the food.

Therefore, according to the embodiment of the present invention, a turntable, a motor, and rollers used in the side emission type microwave range are not necessary.

Consequently, according to the embodiment of the present invention, it is not necessary to provide a space for storing or providing separate parts, such as the motor and the rollers, in the lower part of the cooking chamber, so that it is possible to reduce the total volume of the microwave range. Furthermore, according to the embodiment of the present invention, the turntable is not provided in the cooking chamber 10, so that it is possible to maximize space utilization of the cooking chamber 10.

Furthermore, according to the embodiment of the present invention, it is possible to uniformly heat food by the microwaves radiated from the entire upper surface without rotation, and to cook the food by putting containers having various sizes and shapes into the cooking chamber.

The aforementioned configuration of the embodiment of FIG. 1 may be implemented using the radiation module 30 exemplified in FIG. 2 to FIG. 4.

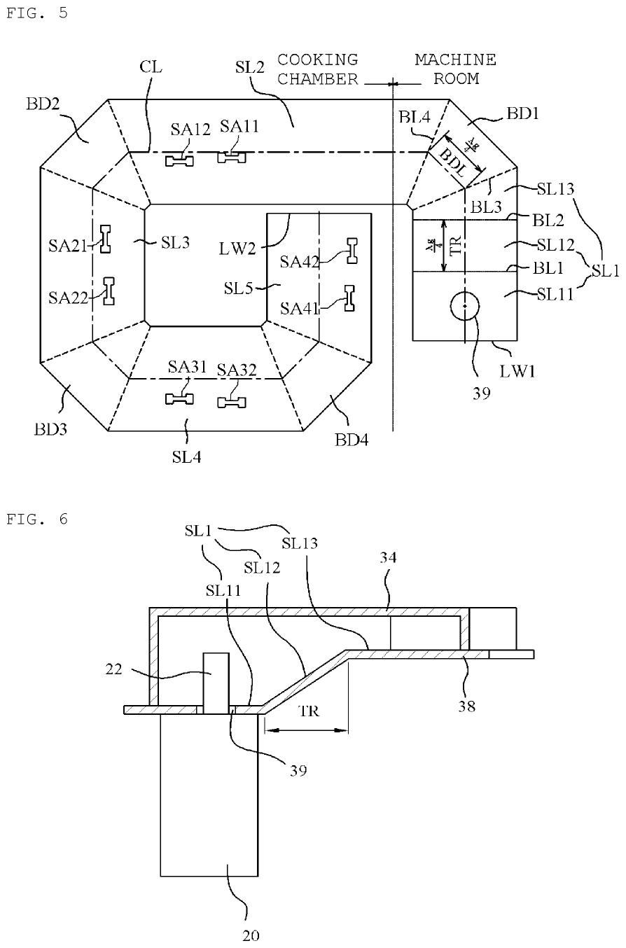

FIG. 2 is a perspective view exemplifying a state in which the magnetron 20 and the radiation module 30 provided in a case of the microwave range are coupled to each other, and FIG. 3 is a plan view of the radiation module 30. FIG. 4 is a plan view exemplifying a base 32 of the radiation module 30 from which the cover 34 has been removed. Hereinafter, a configuration of the radiation module 30 will be described with reference to FIG. 2 to FIG. 4.

The radiation module 30 includes the base 32 and the cover 34 that decides a shape of a waveguide for guiding microwaves, and has a waveguide formed by coupling the cover 34 to an upper part of the base 32. A configuration of the waveguide will be described later in detail with reference to FIG. 5.

Firstly, the base 32 includes plates 36 and 38 connected to each other.

The plate 36 covers the entire upper surface of the cooking chamber 10 and is configured such that two or more paired slot antennas are formed along a spiral propagation path of microwaves.

The two or more paired slot antennas are formed in a region, where the cover 34 is coupled to form a waveguide that forms a horizontal spiral propagation path of the microwaves, in a region of the plate 36 of the base 32 as illustrated in FIG. 4.

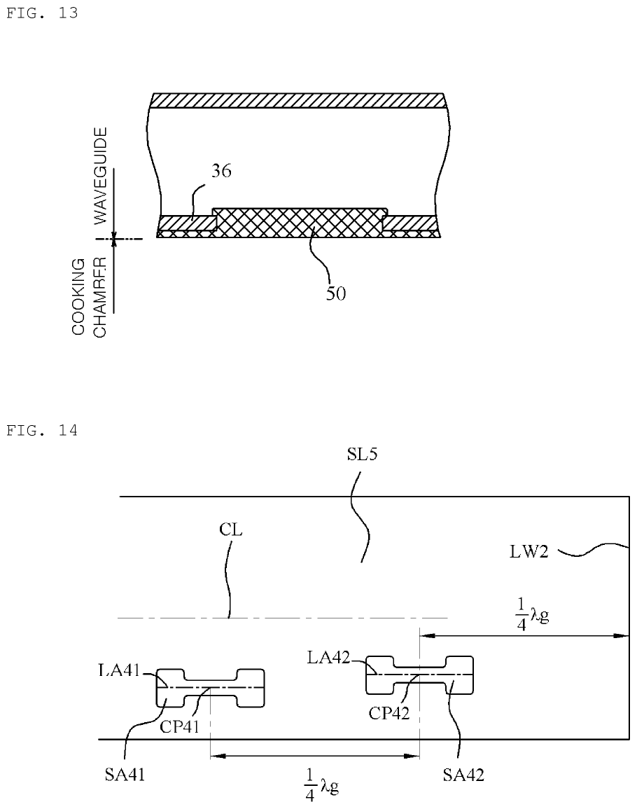

More specifically, in the embodiment of the present invention, four paired slot antennas SA1 to SA4 may be formed on the plate 36 of the base 32 as illustrated in FIG. 4. Among them, the paired slot antenna SA1 includes a pair of slot antennas SA11 and SA12, the paired slot antenna SA2 includes a pair of slot antennas SA21 and SA22, the paired slot antenna SA3 includes a pair of slot antennas SA31 and SA32, and the paired slot antenna SA4 includes a pair of slot antennas SA41 and SA42. The configurations of the four paired slot antennas SA1 to SA4 and the configurations of the slot antennas SA11, SA12, SA21, SA22, SA31, SA32, SA41, and SA42 will be described later with reference to FIG. 10.

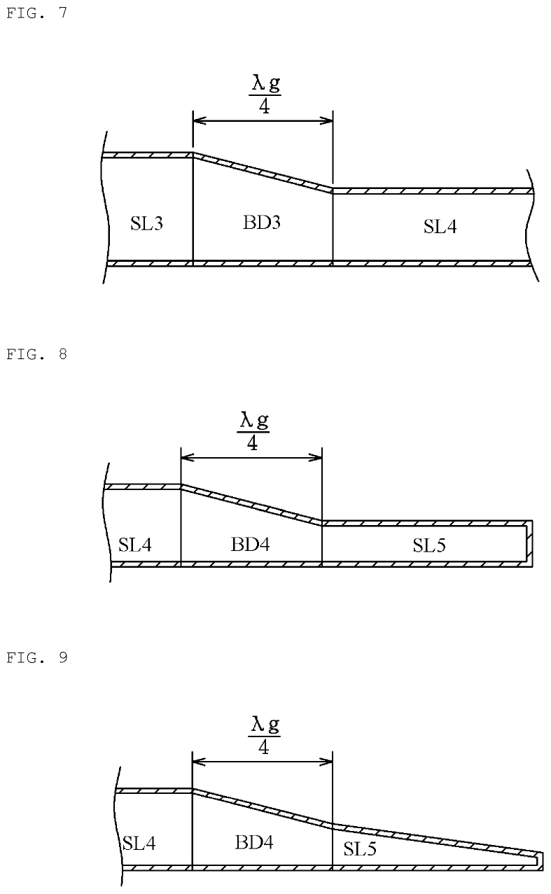

The plate 38 is configured to be connected to a part of the plate 36 and to extend to the machine room on one side of the cooking chamber 10. The plate 38 is formed at one end thereof with a through hole 39 as illustrated in FIG. 4, and the magnetron 20 is coupled to a lower part where the through hole 39 is formed, as illustrated in FIG. 2. The through hole 39 is for allowing an antenna 22 (see FIG. 6) of the magnetron 20 to pass therethrough. The antenna 22 of the magnetron 20 passes through the through hole 39 and is located in the waveguide formed by coupling of the cover 34 and the plate 38 of the base 32. The other end of the plate 38 is connected to a part of the plate 36 forming the upper surface of the cooking chamber 10.

Meanwhile, the cover 34 has a channel formed to face downward and the channel space is formed by sidewalls and end walls LW1 and LW2 at both ends in the longitudinal direction. The cover 34 may be formed in a horizontal spiral shape for deciding the propagation path of the microwaves. More specifically, as illustrated in FIG. 2 and FIG. 3, the cover 34 extends from the upper part of the one end of the plate 38 formed with the through hole 39 to the upper part of the plate 36 via the other end of the plate 38, and has a shape bent in a horizontal spiral shape at the upper part of the plate 36.

That is, the cover 34 is coupled to the upper part of the base 32 so as to seal the channel space while covering the horizontal spiral propagation path of the microwaves, thereby forming the waveguide. Furthermore, the end walls LW1 and LW2 at both ends of the cover 34 where the waveguide extends are preferably configured to have planes perpendicular to the center line of the cover 34, that is, a center line CL of the waveguide.

Although the waveguide is not indicated by a separate reference numeral in FIG. 2 to FIG. 4, the waveguide may be understood as a tube formed by coupling the cover 34 and the base 32. A region indicated by a dotted line in FIG. 4 may be understood as a region where the cover 34 is coupled on the base 32, that is, the waveguide region. In the description of the embodiment, the height, width, and center line of the waveguide may be understood as the height, width, and center line of the channel space of the cover 34.

That is, the waveguide may provide the propagation path of the microwaves extending from the magnetron 20 of the plate 38 to the upper part of the plate 36 by the aforementioned configuration of the cover 34. The propagation path of the microwaves along the waveguide may be defined as a wave guide. The aforementioned waveguide and wave guide will be described later with reference to FIG. 5.

According to the aforementioned configuration, the radiation module 30 introduces the microwaves radiated from the antenna of the magnetron 20 to the upper part of the upper surface of the cooking chamber 10 through the waveguide, and then guides the microwaves in the horizontal spiral shape along the side of the upper surface of the cooking chamber 10. Furthermore, the radiation module 30 radiates the microwaves guided in the horizontal spiral shape from the upper part of the cooking chamber 10 into the cooking chamber 10 through two or more paired slot antennas formed in the base 32. The radiation of the microwaves through the two or more paired slot antennas will be described later with reference to FIG. 10.

Food of the cooking chamber 10 may be heated and cooked by the microwaves radiated into the cooking chamber 10 from the upper radiation module 30 as described above.

Meanwhile, the waveguide formed by the cover 34 and wave guides included in the waveguide may be described with reference to FIG. 5.

The cover 34 may have a horizontal spiral structure in which straight sections and bent sections are combined with one another. Therefore, the waveguide includes straight wave guides SL1 to SL5 corresponding to the straight sections of the cover 34 and bends BD1 to BD4 corresponding to the bent sections of the cover 34, and may be formed in a horizontal spiral shape by sequentially connecting the straight wave guides SL1 to SL5 to the bends BD1 to BD4. Here, the bends BD1 to BD4 are exemplified as a linear shape, but may be implemented in a curved shape according to the intention of a manufacturer.

The waveguide is formed over the machine room and the cooking chamber 10.

Firstly, the configuration of the waveguide of the machine room will be described.

The waveguide of the machine room is formed by the cover 34 coupled on the plate 38 and includes the straight wave guide SL1 and the bend BD1.

The straight wave guide SL1 is formed in parallel to the sidewall of the cooking chamber and is configured to guide the straight propagation of the microwaves radiated from the antenna 22 inserted through the through hole 39. A detailed configuration of the aforementioned straight wave guide SL1 may be described with reference to FIG. 6. FIG. 6 is a sectional view taken along line A-A of FIG. 3.

Referring to FIG. 6, the straight wave guide SL1 includes a first section SL11 having a first height for receiving the antenna 22 of the magnetron 20, a second section SL13 having a second height lower than the first height, and a transition section SL12 connecting the first section SL11 and the second section SL13 to each other, and is configured such that the first section SL11, the second section SL13, and the transition section SL12 have the same width and are connected to one another in a straight line.

The second section SL13 of the straight wave guide SL1 is designed to have a second height for efficiently radiating the microwaves of the antenna 22. However, the first section SL11 of the straight wave guide SL1 is designed to have the first height much higher than the second height in order to receive the antenna 22 of the magnetron 20 protruding upward.

For this reason, the first section SL11 and the second section SL13 of the straight wave guide SL1 have a height difference while being parallel to each other. In order to solve the aforementioned height difference, the transition section SL12 having an inclined surface rising from the first section SL11 to the second section SL13 is formed.

However, reflected waves are formed at a boundary line BL1 between the first section SL11 and the transition section SL12 and a boundary line BL2 between the transition section SL12 and the second section SL13. The aforementioned reflected waves may cause destructive interference for the microwaves propagating in the straight direction through the straight wave guide SL1.

The transition section SL12 has a preset length such that the reflected waves cancel each other by interference. The length of the transition section SL12 may be defined as an interval TR between the first section SL11 and the second section SL13, and is preferably set as ¼ λ_{g} that is a length corresponding to ¼ of the wavelength of the microwaves. Here, λ_{g} denotes the wavelength of the microwaves in the waveguide.

In the aforementioned straight wave guide SL1, the reflected waves generated at the boundary lines BL1 and BL2 have an inverted phase difference and cancel each other at the position of the boundary line BL1.

Therefore, the microwaves of the antenna 22 may propagate to the second section of the straight wave guide SL1 and the bend BD1 without being influenced by the reflected waves generated at the boundary lines BL1 and BL2 of the transition section SL12.

Meanwhile, the bend BD1 is connected to the straight wave guide SL1 and is configured to turn the microwaves at a right angle in a first direction so as to introduce the microwaves into the upper part of the upper surface of the cooking chamber 10. The first direction may be exemplified as the horizontal left from the propagation direction of the microwaves, and the same is applied to the following description.

The bend BD1 vertically connects the straight wave guide SL1 on the plate 38 and the straight wave guide SL2 on the plate 36, and serves to transmit the microwaves of the straight wave guide SL1 to the straight wave guide SL2.

The bend BD1 may be defined as a bent section between a boundary line BL3 contacting the straight wave guide SL1 and a boundary line BL4 contacting the straight wave guide SL2 extending from the upper part of the upper surface of the cooking chamber 10.

According to the aforementioned configuration, the bend BD1 primarily turns the microwaves at 45° in the first direction at the boundary line BL3 and secondarily turns the microwaves in the first direction at 45° at the boundary line BL4 so as to allow the microwaves to propagate. As a consequence, the bend BD1 turns the microwaves having passed the straight wave guide SL1 at a right angle in the first direction and allows the microwaves to propagate toward the straight wave guide SL2.

Preferably, the bend BD1 is configured such that intersections between the center line CL of the width of the waveguide and the boundary lines BL3 and BL4 are spaced apart from each other by ¼ λ_{g} that is the length corresponding to ¼ of the wavelength of the microwaves.

Reflected waves may be formed at the boundary lines BL3 and BL4 and may cause destructive interference for the microwave.

However, the intersections between the center line CL of the width of the waveguide and the boundary lines BL3 and BL4 of the bend BD1 are configured to be spaced apart from each other by ¼ λ_{g} that is the length corresponding to ¼ of the wavelength of the microwaves, so that the reflected waves generated at the boundary lines BL3 and BL4 of the bend BD1 have an inverted phase difference and cancel each other at the position of the boundary line BL3.

Therefore, in the bend BD1, the microwaves may be introduced into the straight wave guide SL2 on the upper part of the upper surface of the cooking chamber 10 without being influenced by the reflected waves generated at the boundary lines BL3 and BL4.

Next, the configuration of the waveguide on the upper part of the upper surface of the cooking chamber 10 will be described.

The waveguide on the upper part of the upper surface of the cooking chamber 10 is configured to extend in a horizontal spiral shape.

The waveguide on the upper surface of the cooking chamber 10 is formed by the cover 34 coupled on the plate 36, and is configured by sequentially connecting the straight wave guide SL2, the bend BD2, the straight wave guide SL3, the bend BD3, the straight wave guide SL4, the bend BD4, and the straight wave guide SL5 to one another.

Among them, the straight wave guides SL2 to SL5 guide the straight propagation of the microwaves propagating and bent at a right angle in the first direction in the bends BD1 to BD4 of the previous sections. Preferably, the straight wave guides SL2 to SL5 have gradually shorter lengths in order of arrangement such that the waveguide has a spiral shape.

Furthermore, like the bend BD1, the bends BD2 to BD4 formed among the straight wave guides SL2 to SL5 may also be defined as bent sections between the boundary line contacting the straight wave guide that provides the microwaves and the boundary line contacting the straight wave guide that is to provide the microwaves. Preferably, the bends BD2 to BD4 are also configured such that intersections between the center line CL of the width of the waveguide and the boundary lines are spaced apart from each other by ¼ λ_{g} that is the length corresponding to ¼ of the wavelength of the microwaves in the waveguide.

According to the aforementioned configuration, reflected waves generated at the boundary lines cancel each other, and the bends BD2 to BD4 may turn the microwaves at a right angle in the first direction so as to allow the microwaves to propagate without being influenced by the reflected waves.

The waveguide may have the horizontal spiral structure by the combination of the straight wave guides and the bends as illustrated in FIG. 5, and introduce the microwaves radiated from the magnetron 20 into the upper part of the upper surface of the cooking chamber 10 and then allow the microwaves to propagate in the horizontal spiral shape.

Meanwhile, the farther the microwaves are, the lower the output thereof. A change in the output of the microwaves due to the propagation may be compensated by increasing the conductance of the waveguide by decreasing the height of the waveguide as the propagation length becomes longer. The conductance of the waveguide increases as the height decreases. That is, the straight wave guides may be configured to have heights that decrease in a plurality of steps with respect to the propagation direction of the microwave.

To this end, in the present invention, a transition section may be formed in at least one of the straight wave guides SL2 to SL5 and the straight wave guide provided with the transition section may have a structure in which the height decreases with respect to the propagation direction of the microwave.

That is, the straight wave guide provided with the transition section has a structure in which a first straight section having a first height, the transition section having an inclined surface of which the height becomes lower, and a second straight section having a second height lower than the first height are connected to one another in a straight line. Preferably, the first straight section and the second straight section are spaced apart from each other by the length corresponding to ¼ of the wavelength of the microwaves in the waveguide. Since the structure of the straight wave guide provided with the transition section and the cancellation effect of reflected waves may be understood with reference to the transition section of the straight wave guide SL1, a detailed description thereof will be omitted.

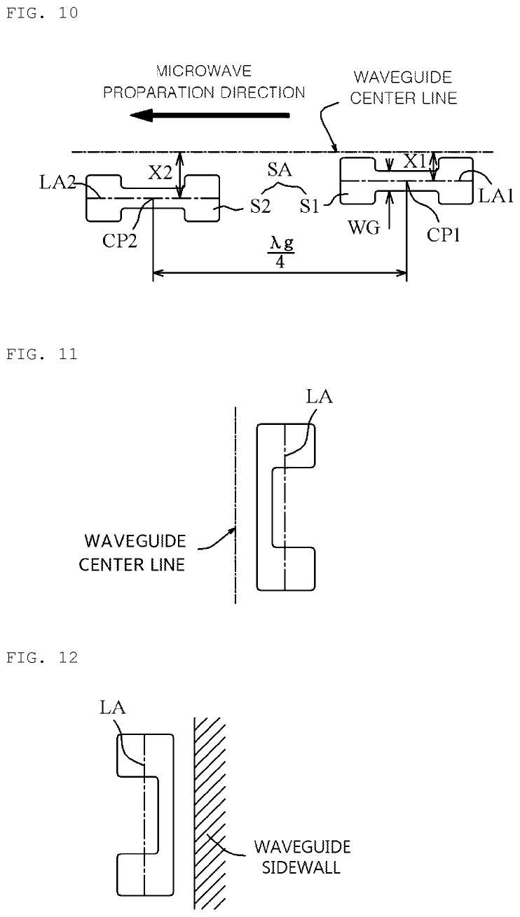

Furthermore, in the present invention, a transition section may be formed in a bend as illustrated in FIG. 7 and FIG. 8.

FIG. 7 is a sectional view exemplifying a connection state among the straight wave guide SL3, the bend BD3, and the straight wave guide SL4, and FIG. 8 is a sectional view exemplifying a connection state among the straight wave guide SL4, the bend BD4, and the straight wave guide SL5. FIG. 7 and FIG. 8 are rotational sectional views exemplifying a plane rotated based on the boundary line between the bends BD3 and BD4.

Referring to FIG. 7, the straight wave guide SL4 has a height lower than that of the straight wave guide SL3, and the bend BD3 is configured to have an inclined surface in order to solve a height difference between the straight wave guides SL3 and SL4. As described above, the bend BD3 is configured such that the intersections between the center line CL of the width of the waveguide and the boundary lines are spaced apart from each other by ¼ λ_{g} that is the length corresponding to ¼ of the wavelength of the microwaves in the waveguide. Therefore, reflected waves generated at boundary lines at both ends of the bend BD3 may cancel each other because they have an inverted phase difference.

In FIG. 8, the bend BD4 is also configured to have an inclined surface in order to solve a height difference between the straight wave guides SL4 and SL5, and reflected waves generated at boundary lines at both ends of the bend BD4 may cancel each other because they have an inverted phase difference as described above.

In the present invention, the embodiment of FIG. 7 and FIG. 8 exemplifies that the conductance of the waveguide is increased by configuring the straight wave guide SL4 to be lower than the straight wave guide SL3 and configuring the straight wave guide SL5 to be lower than the straight wave guide SL4.

Furthermore, the straight wave guide SL5 which the microwaves finally reaches may be configured to have an inclined surface gradually lowered as illustrated in FIG. 9. As the inclined surface of the straight wave guide SL5 is gradually lowered as illustrated in FIG. 9, the conductance of the waveguide can be increased, and the radiation amount of the microwaves through the paired slot antennas of the straight wave guide SL5 can be increased.

With reference to FIG. 10, an embodiment of the paired slot antennas applied to the waveguide of the present invention will be described.

In FIG. 10, the paired slot antenna is represented by SA and a pair of slot antennas included in the paired slot antenna SA are denoted by S1 and S2. The slot antennas S1 and S2 are formed as slots penetrating the plate 36 of the base and a detailed shape of the slots will be described later.

The paired slot antenna SA of the present invention includes the two slot antennas S1 and S2.

The two slot antennas S1 and S2 are arranged on the same side with respect to the center line of the waveguide when major axes LA1 and LA2 are placed in parallel to the propagation direction of the waveguide, that is, the center line of the waveguide.

In the paired slot antenna SA, the microwaves reach first the slot antenna S1 of the slot antennas S1 and S2, and a distance X1 between the major axis LA1 of the slot antenna S1, at which the microwaves reach first, and the center line of the waveguide is smaller than a distance X2 between the major axis LA2 of the slot antenna S2 and the center line of the waveguide.

Preferably, a distance between centers CP1 and CP2 of the slot antennas S1 and S2 is set to be ¼ of the wavelength of the microwaves in the waveguide.

According to the aforementioned configuration, as the distance between the centers CP1 and CP2 of the slot antennas S1 and S2 has a distance corresponding to ¼ of the wavelength of the microwaves in the waveguide, a reflected wave generated by the slot antenna S1 and a reflected wave generated by the slot antenna S2 with respect to the microwaves propagating along the waveguide can cancel each other by destructive interference in the embodiment of the present invention. Therefore, the microwaves propagating along the waveguide can propagate without being influenced by the reflected waves by the slot antennas S1 and S2.

Furthermore, according to the aforementioned configuration, as the distance between the centers CP1 and CP2 of the slot antennas S1 and S2 has a distance corresponding to ¼ of the wavelength of the microwaves in the waveguide, the microwaves radiated to the cooking chamber 10 from the slot antennas S1 and S2 have a phase difference of ¼ cycle. Therefore, the microwaves radiated from the two slot antennas S1 and S2 can be radiated for cooking into the cooking chamber 10 without interference.

Furthermore, the microwaves radiated into the cooking chamber 10 from the slot antennas S1 and S2 have a phase difference of ¼ cycle, so that food can be heated and cooked by the microwaves radiated with temporal uniformization.

Furthermore, the slot antennas S1 and S2 are preferably configured to have the same shape and the same radiation conductance such that the outputs of the microwaves radiated to the cooking chamber are the same, in order to exhibit a spatially uniform heating effect on food.

In the embodiment of the present invention, each of the slot antennas S1 and S2 is configured as a resonant type.

The embodiment of the present invention needs to be configured such that a limited number of paired slot antennas are disposed in a limited space such as an upper surface of the cooking chamber and the microwaves are emitted into the cooking chamber as effectively as possible.

To this end, each of the slot antennas S1 and S2 needs to be manufactured as a resonant type.

In general, a slot antenna is configured using a rectangular slot having a narrow width and a long length in order to configure an array antenna, and resonance may occur when the length of the slot is ½ of the wavelength of microwaves in a free space.

However, the length of the slot becomes too long to configure the paired slot antenna SA of the present invention by using the aforementioned method, thereby causing a restriction such as overlapping of slots.

To this end, the paired slot antenna SA of the present invention is implemented with the two separate slot antennas S1 and S2 while avoiding interference.

More specifically, each of the slot antennas S1 and S2 of the paired slot antenna SA of the present invention is configured in a dumbbell shape symmetrical about each of the major axes LA1 and LA2.

That is, each of the slot antennas S1 and S2 is configured in the dumbbell shape symmetrical about each of the major axes LA1 and LA2, in which rectangular through holes are formed at both ends thereof, an intermediate connection through hole is formed, the rectangular through holes at both ends thereof are integrally connected to each other by the intermediate connection through hole, and the width of the connection through hole is narrower than that of the rectangular through hole. The resonance capacitance of the slot antennas S1 and S2 is decided by a width WG of the connection through hole. The narrower the width of the connection through hole, the higher the resonance capacitance.

The slot antennas S1 and S2 may be configured to have a short length as the resonance capacitance increases, and the inductance is little affected.

According to the aforementioned configuration, the slot antennas S1 and S2 have a reduced resonance frequency, and thus they can be implemented with a short length in correspondence to the same microwave frequency. That is, the paired slot antenna SA is configured using the slot antennas S1 and S2 configured in the dumbbell shape symmetrical about the major axes LA1 and LA2, and as a consequence, a pair of resonant slot antennas with a short length can be implemented in two separate regions while avoiding interference.

In addition, the paired slot antenna SA of the present invention can be implemented using slot antennas having various shapes.

When a plurality of slot antennas are disposed, a distance between a major axis of each slot antenna and the center line of a waveguide serves as an important parameter for uniform microwave radiation of the plurality of slot antennas.

When a dumbbell-like slot antenna is disposed as illustrated in FIG. 10, rectangular through holes at both ends of the slot antenna may be disposed too close to the center line of the waveguide or a part of the rectangular through holes at both ends of the slot antenna may cross the center line of the waveguide. In such a case, the slot antenna may be configured such that a connection through hole is formed at a position asymmetric about a major axis LA, that is, a position close to the center line of the waveguide as illustrated in FIG. 11.

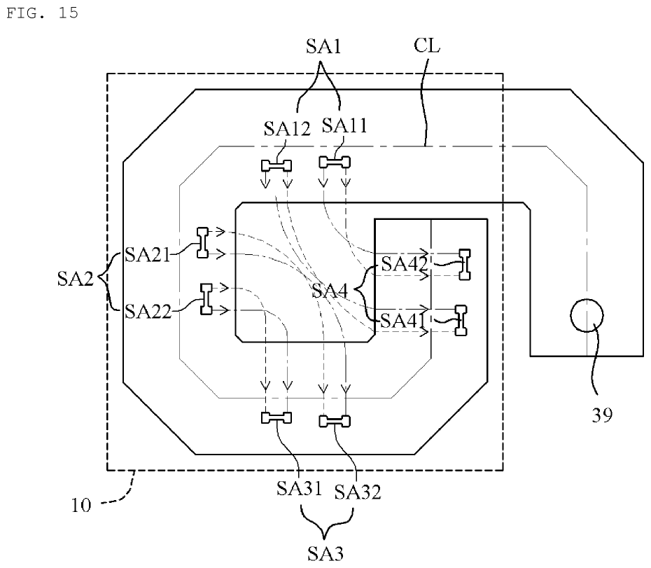

Furthermore, when the dumbbell-like slot antenna is disposed as illustrated in FIG. 10, it may be difficult to dispose the major axis LA of the slot antenna sufficiently close to the sidewall of the waveguide. In such a case, the slot antenna may be configured such that the connection through hole is formed at a position asymmetric about the major axis LA, that is, a position close to the sidewall of the waveguide, as illustrated in FIG. 12.

Furthermore, the paired slot antenna SA of the present invention may be configured by filling a dielectric into a perforated space of each of the slot antennas S1 and S2 in order to increase resonance capacitance. That is, as illustrated in FIG. 13, a dielectric 50 may be inserted into the perforated space of each of the slot antennas S1 and S2. Referring to FIG. 13, the dielectric 50 may be configured as a dielectric cover including a protrusion inserted while covering an entire surface of one slot antenna and filling the perforated space. Differently from this, although not illustrated in the drawings, the dielectric 50 may be configured as a dielectric cover including protrusions inserted while covering entire surfaces of two slot antennas and filling the perforated space of each slot antenna.

In the case of FIG. 13, the resonance frequency of the slot antenna is decided according to the amount (area) of the dielectric inserted into the perforated space of the slot in which an electric field is focused, and the dielectric entering the waveguide outside the perforated space or located outside the waveguide may secondarily affect the resonance frequency.

Since the resonance capacitance is increased by the aforementioned dielectric, the length of each of the slot antennas S1 and S2 of the paired slot antenna SA may be decreased corresponding to the increase in the resonance capacitance.

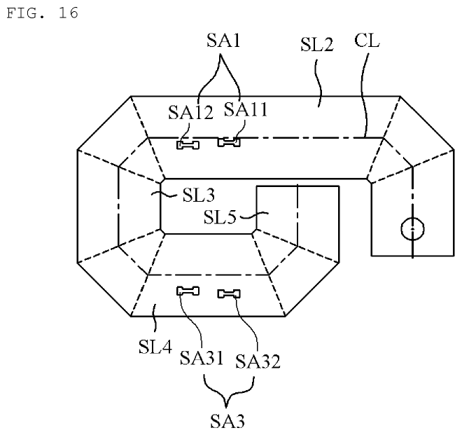

Furthermore, when the paired slot antenna SA is configured in the straight wave guide SL5 which the microwaves finally reach, an end wall LW2 is formed to be perpendicular to the center line CL of the waveguide at a point corresponding to ¼ of the wavelength of the microwaves from a center CP42 of a major axis LA42 of the slot antenna SA42 positioned last as illustrated in FIG. 14. According to such a configuration, since the remaining microwaves that are not radiated from the straight wave guide SL5 are reflected from the end wall LW2 and causes constructive interference while returning, they can be efficiently radiated.

In the embodiment of the radiation module 30 of the present invention, the horizontal spiral waveguide may be formed as described in FIG. 2 to FIG. 9 and two or more paired slot antennas may be formed on the bottom surface of the waveguide as illustrated in FIG. 10 to FIG. 14.

Referring to FIG. 5, the microwaves propagate along the waveguide formed by the cover 34 and are radiated into the cooking chamber 10 through the paired slot antennas SA1 to SA4.

The waveguide includes the straight wave guides SL2 to SL5 that guide the microwaves in the straight direction in correspondence to each side of the rectangular upper surface of the cooking chamber 10, and the bends BD2 to BD4 that spirally connect the straight wave guides SL2 to SL5 and guide the microwaves at a right angle in the first direction.

Accordingly, the microwaves can be introduced into the upper part of the upper surface of the cooking chamber 10 and then propagate in a spiral shape.

The microwaves are radiated to the cooking chamber 10 through the paired slot antennas while spirally propagating in the upper part of the cooking chamber 10 along the waveguide.

As described above, in order to radiate the microwaves to the cooking chamber 10, the paired slot antennas SA1 and SA2 of the straight wave guides SL2 and SL3 are formed on the center side of the upper surface of the cooking chamber 10 with respect to the center line CL of the width of the waveguide, and the paired slot antennas SA3 and SA4 of the straight wave guides SL4 and SL5 are formed on the side of the upper surface of the cooking chamber 10 with respect to the center line CL of the width of the waveguide.

Then, depending on the order in which the microwaves reach, the slot antennas SA11, SA12, SA21, and SA22 of the paired slot antennas SA1 and SA2 are formed close to the center line CL from the center side of the upper surface of the cooking chamber 10 with respect to the center line CL of the width of the waveguide, and the slot antennas SA31, SA32, SA41, and SA42 of the paired slot antennas SA3 and SA4 are formed close to the center line CL from the side of the upper surface of the cooking chamber 10 with respect to the center line CL of the width of the waveguide.

The microwaves propagate along the waveguide and are gradually radiated to the cooking chamber 10 through the slot antennas SA11, SA12, SA21, SA22, SA31, SA32, SA41, and SA42 of the straight wave guides SL2 to SL5, and the outputs of the microwaves are reduced by the radiated amount according to the propagation.

Therefore, in order to uniformize the output of the microwaves radiated from each of the slot antennas of the straight wave guides SL2 to SL5, the conductance of the slot antenna that receives the microwaves later needs to be designed to be larger than that of the slot antenna that first receives the microwave.

To this end, in the embodiment of the present invention, as described with reference to FIG. 7 to FIG. 9, the conductance of the slot antenna can be gradually increased by gradually decreasing the height of the waveguide, and by gradually increasing the distance between the center line CL of the width of the waveguide and the slot antennas SA11, SA12, SA21, SA22, SA31, SA32, SA41, and SA42.

According to the aforementioned configuration of the waveguide, the microwaves can be radiated to the cooking chamber 10 in a uniform amount for each slot antenna.

The microwaves form an electric field in a direction perpendicular to the slot antenna when radiated to the cooking chamber 10. In the embodiment of the present invention, the slot antennas are disposed to prevent destructive inference of the microwaves in the cooking chamber.

When the slot antennas are located on opposite sides with respect to the center line CL of the waveguide while facing each other, the directions of the electric fields by the microwaves are formed opposite to each other.

Accordingly, when the slot antennas are disposed along the circumference of the upper surface of the cooking chamber 10 and disposed on the same side with respect to the center line of the waveguide, the phases of the microwaves radiated from the slot antennas of the straight wave guides facing each other are directed opposite to each other. Therefore, in such a case, the microwaves may cause destructive interference in the cooking chamber 10.

In order to prevent the destructive interference, in the embodiment of the present invention, the slot antennas may be disposed in order of the center-center-side-side of the upper surface of the cooking chamber 10 with respect to the center line CL of the waveguide in correspondence to “the straight wave guide SL2-the straight wave guide SL3-the straight wave guide SL4-the straight wave guide SL5”, as illustrated in FIG. 15.

Differently from this, in the present invention, although not illustrated in the drawing, the slot antennas may be disposed in order of the center-side-center-side, side-side-center-center or side-center-side-center of the upper surface of the cooking chamber 10 with respect to the center line CL of the waveguide in correspondence to “the straight wave guide SL2-the straight wave guide SL3-the straight wave guide SL4-the straight wave guide SL5”.

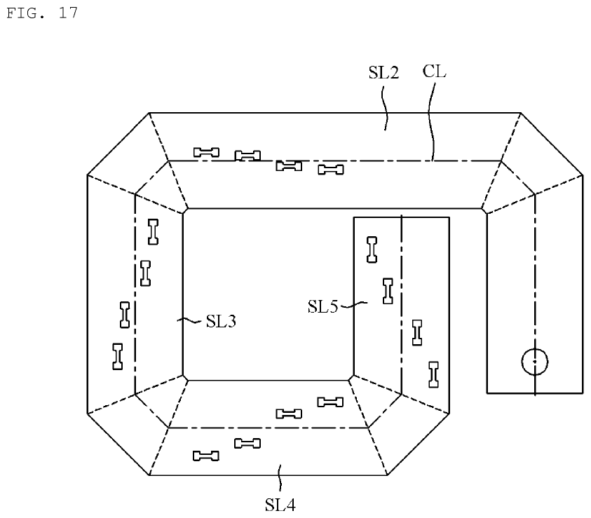

Meanwhile, when the low output of the microwaves is required, the paired slot antennas SA1 and SA3 may be formed on the bottom surface of the straight wave guides SL2 and SL4 facing each other, as illustrated in FIG. 16 in the embodiment of the present invention.

In such a case, the paired slot antenna SA1 of the straight wave guide SL2, which the microwaves reach first, is formed on the center side of the upper surface of the cooking chamber 10 with respect to the center line CL of the width of the waveguide, and the paired slot antenna SA4 of the straight wave guide SL4, which the microwaves reach later, is formed on the side of the upper surface of the cooking chamber 10 with respect to the center line CL of the width of the waveguide.

Then, depending on the order in which the microwaves reach, the slot antennas SA11 and SA12 of the paired slot antenna SA1 are formed close to the center line CL from the center side of the upper surface of the cooking chamber 10 with respect to the center line CL of the width of the waveguide, and the slot antennas SA41 and SA42 of the paired slot antenna SA4 are formed close to the center line CL from the side of the upper surface of the cooking chamber 10 with respect to the center line CL of the width of the waveguide.

Furthermore, when the high output of the microwaves is required, each of the straight wave guides SL1 to SL4 includes a first paired slot antenna including a first slot antenna and a second slot antenna and formed on the center side of the upper surface of the cooking chamber 10 with respect to the center line CL of the width of the waveguide, and a second paired slot antenna including a third slot antenna and a fourth slot antenna and formed on the side of the upper surface of the cooking chamber 10 with respect to the center line CL of the width of the waveguide as illustrated in FIG. 17 in the embodiment of the present invention.

Then, depending on the order in which the microwaves reach, the first slot antennas and the second slot antennas of the straight wave guides SL1 to SL4 are formed close to the center line CL from the center side of the upper surface of the cooking chamber 10 with respect to the center line CL of the width of the waveguide, and the third slot antennas and the fourth slot antennas of the straight wave guides SL1 to SL4 are formed close to the center line CL from the side of the upper surface of the cooking chamber 10 with respect to the center line CL of the width of the waveguide.

Then, in the straight wave guides SL1 and SL2, the first paired slot antenna is disposed such that the microwaves reach the first paired slot antenna before the second paired slot antenna. Furthermore, in the straight wave guides SL3 and SL4, the second paired slot antenna is disposed such that the microwaves reach the second paired slot antenna before the first paired slot antenna.

Preferably, the present invention is configured such that, in order to prevent the microwaves to cause destructive interference in the cooking chamber 10, the paired slot antennas are alternately disposed with respect to the center line of the width of the waveguide so as to cause phase inversion as illustrated in FIG. 15 to FIG. 17.

When the area of the upper surface of the cooking chamber 10 is increased, the number of paired slot antennas may be changed. In such a case, the paired slot antennas may be variously combined with one another for phase inversion.

According to the aforementioned embodiment, the present invention is configured to radiate the microwaves for cooking food in the cooking chamber from the upper part of the cooking chamber.

Consequently, according to the present invention, rotation for uniformly heating food is not necessary, thereby achieving simplification of parts, a reduction in a space of the microwave range, efficient space utilization of the cooking chamber, and the use of various containers for cooking.

Furthermore, according to the present invention, it is possible to reduce the influence of reflected waves on the microwave, to uniformly radiate the microwaves into the cooking chamber without destructive interference, and to improve a heating effect by a microwave phase difference.

While various embodiments have been described above, it will be understood to those skilled in the art that the embodiments described are by way of example only. Accordingly, the disclosure described herein should not be limited based on the described embodiments.

1. A radiation module of a microwave range, comprising:
a waveguide configured to introduce microwaves radiated through an antenna of a magnetron into an upper part of a rectangular upper surface of a cooking chamber, to horizontally guide the microwaves along sides of the upper surface in the upper part of the upper surface, and to radiate the microwaves to the cooking chamber through two or more paired slot antennas formed on a bottom surface,
wherein the waveguide comprises:
two or more straight wave guides corresponding to sides of the rectangular upper surface of the cooking chamber and configured to straightly guide the microwaves; and
bends configured to connect the straight wave guides to each other and to guide the microwaves at a right angle in a first direction,
wherein one or more paired slot antennas are formed in each of the straight wave guides,
each of the paired slot antennas includes two slot antennas perforated along major axes, and
the two slot antennas are formed such that a distance differs in the same direction with respect to a center line of a width of the waveguide, the major axes are parallel to a propagation direction of the microwave, and centers of the major axes are formed to be spaced apart from each other by a distance corresponding to ¼ of a wavelength of the microwaves in the waveguide.

2. The radiation module of the microwave range according to claim 1, further comprising:
a first straight wave guide configured to guide straight propagation of the microwaves of the antenna of the magnetron; and
a first bend formed between a second straight wave guide at a position where the microwaves are introduced to the upper part of the upper surface of the cooking chamber and the first straight wave guide, and configured to bend the microwaves of the first straight wave guide in the first direction and to guide the microwaves toward the second straight wave guide.

3. The radiation module of the microwave range according to claim 2, wherein the first straight wave guide includes a first section having a first height for receiving the antenna, a second section having a second height lower than the first height, and a transition section connecting the first section and the second section to each other, and
the first section and the second section are spaced apart from each other by a distance corresponding to ¼ of the wavelength of the microwaves.

4. The radiation module of the microwave range according to claim 2, wherein the bends and the first bend are defined between a first boundary line at which the propagation direction of the microwaves is primarily bent at 45° in the first direction and a second boundary line at which the propagation direction of the microwaves is secondarily bent at 45° in the first direction, and
intersections between the center line of the width of the waveguide and the first and second boundary lines are spaced apart from each other by a distance corresponding to ¼ of the wavelength of the microwaves in the waveguide.

5. The radiation module of the microwave range according to claim 1, wherein a first paired slot antenna is formed on a bottom surface of a first straight wave guide,
a second paired slot antenna is formed on a bottom surface of a second straight wave guide facing the first straight wave guide,
a first slot antenna and a second slot antenna included in the first paired slot antenna are formed on a center side of the upper surface of the cooking chamber with respect to the center line of the width of the waveguide,
a third slot antenna and a fourth slot antenna included in the second paired slot antenna are formed on the sides of the upper surface of the cooking chamber with respect to the center line, and
the first slot antenna is formed closer to the center line than the second slot antenna and the third slot antenna is formed closer to the center line than the fourth slot antenna, depending on an arrival order of the microwaves.

6. The radiation module of the microwave range according to claim 5, wherein a third paired slot antenna is further formed on a bottom surface of a third straight wave guide,
a fourth paired slot antenna is further formed on a bottom surface of a fourth straight wave guide facing the third straight wave guide,
a fifth slot antenna and a sixth slot antenna included in the third paired slot antenna are formed on the center side of the upper surface of the cooking chamber with respect to the center line,
a seventh slot antenna and an eighth slot antenna included in the fourth paired slot antenna are formed on the side of the upper surface of the cooking chamber with respect to the center line,
the first, second, fifth, and sixth slot antennas are formed closer to the center line as the arrival order of the microwaves is faster, and
the third, fourth, seventh, and eighth slot antennas are formed closer to the center line as the arrival order of the microwaves is faster.

7. The radiation module of the microwave range according to claim 6, wherein the microwaves reach in order to the first, second, third, and fourth straight wave guides, and the first, second, third, and fourth paired slot antennas are formed on the center-center-side-side of the upper surface of the cooking chamber with respect to the center line.

8. The radiation module of the microwave range according to claim 6, wherein the microwaves reach in order to the first, second, third, and fourth straight wave guides, and the first, second, third, and fourth paired slot antennas are formed on the center-side-center-side of the upper surface of the cooking chamber with respect to the center line.

9. The radiation module of the microwave range according to claim 6, wherein the microwaves reach in order to the first, second, third, and fourth straight wave guides, and the first, second, third, and fourth paired slot antennas are formed on the side-center-side-center of the upper surface of the cooking chamber with respect to the center line.

10. The radiation module of the microwave range according to claim 6, wherein the microwaves reach in order to the first, second, third, and fourth straight wave guides, and the first, second, third, and fourth paired slot antennas are formed on the side-side-center-center of the upper surface of the cooking chamber with respect to the center line.

11. The radiation module of the microwave range according to claim 1, wherein the waveguide includes first to fourth straight wave guides corresponding to the sides of the rectangular upper surface of the cooking chamber and straightly and sequentially guiding the microwaves and first to third bends connecting the first to fourth straight wave guides to each other and bending the microwaves at a right angle in the first direction to guide the microwaves,
each of the first to fourth straight wave guides includes a first paired slot antenna formed on a center side of the upper surface of the cooking chamber with respect to the center line of the width of the waveguide and including a first slot antenna and a second slot antenna, and a second paired slot antenna formed on the sides of the upper surface of the cooking chamber with respect to the center line of the width of the waveguide and including a third slot antenna and a fourth slot antenna,
the first slot antenna and the second slot antenna are formed closer to the center line as an arrival order of the microwaves is faster,
the third slot antenna and the fourth slot antenna are formed closer to the center line as an arrival order of the microwaves is faster,
the first paired slot antenna is disposed in the first and second straight wave guides such that the microwaves reach the first paired slot antenna before the second paired slot antenna, and
the second paired slot antenna is disposed in the third and fourth straight wave guides such that the microwaves reach the second paired slot antenna before the first paired slot antenna.

12. The radiation module of the microwave range according to claim 1, wherein, in at least one of the straight wave guides, a first straight section having a first height, a transition section having an inclined surface of which the height becomes lower, and a second straight section having a second height lower than the first height are connected to one another in a straight line, and the first straight section and the second straight section are spaced apart from each other by a length corresponding to ¼ of the wavelength of the microwaves in the waveguide.

13. The radiation module of the microwave range according to claim 1, wherein the wave guide comprises:
the two straight wave guides sequentially disposed with a height difference; and
a bend configured to interconnect the two straight wave guides with the height difference,
wherein the bend has an inclined surface and is defined between a first boundary line at which the propagation direction of the microwaves is primarily bent at 45° in the first direction and a second boundary line at which the propagation direction of the microwaves is secondarily bent at 45° in the first direction, and
intersections between the center line of the width of the waveguide and the first and second boundary lines are spaced apart from each other by a distance corresponding to ¼ of the wavelength of the microwaves in the waveguide.

14. The radiation module of the microwave range according to claim 1, wherein the straight wave guide, which finally receives the microwaves, has an inclined surface lowered toward an end wall of the waveguide.

15. The radiation module of the microwave range according to claim 1, wherein the slot antennas of the paired slot antenna closest to an end wall of the straight wave guide which the microwaves finally reach are formed such that a center of a major axis and the end wall are spaced apart from each other by a distance corresponding to ¼ of the wavelength of the microwaves in the waveguide.

16. The radiation module of the microwave range according to claim 1, wherein the waveguide includes a first straight wave guide and a second straight wave guide,
a first paired slot antenna is formed on a bottom surface of the first straight wave guide, and
a second paired slot antenna is formed on a bottom surface of the second straight wave guide.

17. The radiation module of the microwave range according to claim 1, wherein, between the two slot antennas included in the one paired slot antenna, a slot antenna, which the microwaves reach first, is formed close to the center line of the width of the waveguide.

18. The radiation module of the microwave range according to claim 1, wherein each of the two slot antennas included in the one paired slot antenna includes rectangular through holes at both ends thereof and a connection through hole that connects the rectangular through holes to each other, has a width narrower than widths of the rectangular through holes, and is parallel to the major axis, and
resonance capacitance is adjusted by the width of the connection through hole.

19. The radiation module of the microwave range according to claim 18, wherein each of the two slot antennas is disposed such that the rectangular through holes are symmetrical to each other with respect to the connection through hole, in order to have a dumbbell shape.

20. The radiation module of the microwave range according to claim 18, wherein each of the two slot antennas has a shape in which the rectangular through holes are asymmetrically disposed with respect to the connection through hole.

21. The radiation module of the microwave range according to claim 1, wherein a perforated space of the two slot antennas is filled with a dielectric.

22. The radiation module of the microwave range according to claim 21, further comprising:
a dielectric cover composed of the dielectric,
wherein the dielectric cover further comprises:
a dielectric cover including a protrusion inserted while filling the perforated space of at least one of the two slot antennas

23. A microwave range comprising:
a cooking chamber;
a magnetron configured to radiate microwaves through an antenna; and
a radiation module including a waveguide that introduces the microwaves into an upper part of a rectangular upper surface of a cooking chamber from the antenna and provides a propagation path along which the introduced microwaves are horizontally guided along sides of the upper part of the upper surface of the cooking chamber, and configured to radiate the microwaves to the cooking chamber through two or more paired slot antennas formed on a bottom surface of the waveguide,
wherein each of the paired slot antennas includes two slot antennas perforated along major axes, and
the two slot antennas are formed such that a distance differs in the same direction with respect to a center line of a width of the waveguide, the major axes are parallel to a propagation direction of the microwave, and centers of the major axes are formed to be spaced apart from each other by a distance corresponding to ¼ of a wavelength of the microwaves in the waveguide.

24. The microwave range according to claim 23, wherein the radiation module comprises:
a base including a first plate that covers the upper surface of the cooking chamber and is provided with the two or more paired slot antennas formed along the propagation path of the microwaves and a second plate in which the magnetron is coupled to a lower part of one end thereof, a through hole through which the antenna protrudes upward is formed at the one end, and the other thereof is connected to the first plate; and
a cover receiving the antenna, formed with a channel to cover the propagation path of the microwaves of the first plate via the other end from the one end of the second plate, and forming the waveguide by being coupled to an upper part of the base.

25. The microwave range according to claim 24, wherein the waveguide includes a straight wave guide formed on the second plate and guiding straight propagation of the microwaves radiated from the antenna,
the straight wave guide includes a first section having a first height for receiving the antenna, a second section having a second height lower than the first height, and a transition section connecting the first section and the second section to each other, and
the first section and the second section are spaced apart from each other by a distance corresponding to ¼ of the wavelength of the microwaves.

26. The microwave range according to claim 25, wherein the waveguide further comprises:
a bend connected to the straight wave guide, bending the microwaves at a right angle in a first direction, and introducing the microwaves to the upper part of the upper surface of the cooking chamber,
wherein the bend is defined between a first boundary line at which the propagation direction of the microwaves is primarily bent at 45° in the first direction and a second boundary line at which the propagation direction of the microwaves is secondarily bent at 45° in the first direction, and
intersections between the center line of the width of the waveguide and the first and second boundary lines are spaced apart from each other by a distance corresponding to ¼ of the wavelength of the microwaves in the waveguide.

27. The microwave range according to claim 23, wherein the radiation module comprises:
a base including a plate that covers the upper surface of the cooking chamber and is provided with the two or more paired slot antennas formed along the propagation path of the microwave; and
a cover formed with a channel to cover the propagation path of the microwaves of the plate and forming the waveguide by being coupled to an upper part of the base.

28. The microwave range according to claim 27, wherein the waveguide includes straight wave guides corresponding to the sides of the rectangular upper surface of the cooking chamber and straightly guiding the microwaves and bends connecting the straight wave guides to each other and guiding the microwaves at a right angle in a first direction,
a first paired slot antenna is formed on a bottom surface of a first straight wave guide,
a second paired slot antenna is formed on a bottom surface of a second straight wave guide facing the first straight wave guide,
a first slot antenna and a second slot antenna included in the first paired slot antenna are formed on a center side of the upper surface of the cooking chamber with respect to the center line of the width of the waveguide,
a third slot antenna and a fourth slot antenna included in the second paired slot antenna are formed on the sides of the upper surface of the cooking chamber with respect to the center line, and
the first slot antenna is formed closer to the center line than the second slot antenna and the third slot antenna is formed closer to the center line than the fourth slot antenna depending on an arrival order of the microwave.

29. The microwave range according to claim 28, wherein a third paired slot antenna is further formed on a bottom surface of a third straight wave guide,
a fourth paired slot antenna is further formed on a bottom surface of a fourth straight wave guide facing the third straight wave guide,
a fifth slot antenna and a sixth slot antenna included in the third paired slot antenna are formed on the center side of the upper surface of the cooking chamber with respect to the center line,
a seventh slot antenna and an eighth slot antenna included in the fourth paired slot antenna are formed on the side of the upper surface of the cooking chamber with respect to the center line,
the first, second, fifth, and sixth slot antennas are formed closer to the center line as the arrival order of the microwaves is faster, and
the third, fourth, seventh, and eighth slot antennas are formed closer to the center line as the arrival order of the microwaves is faster.

30. The microwave range according to claim 27, wherein the waveguide includes first to fourth straight wave guides corresponding to the sides of the rectangular upper surface of the cooking chamber and straightly and sequentially guiding the microwaves and first to third bends connecting the first to fourth straight wave guides to each other and bending the microwaves at a right angle in a first direction to guide the microwaves,
each of the first to fourth straight wave guides includes a first paired slot antenna formed on a center side of the upper surface of the cooking chamber with respect to the center line of the width of the waveguide and including a first slot antenna and a second slot antenna, and a second paired slot antenna formed on a side of the upper surface of the cooking chamber with respect to the center line of the width of the waveguide and including a third slot antenna and a fourth slot antenna,
the first slot antenna and the second slot antenna are formed closer to the center line as an arrival order of the microwaves is faster,
the third slot antenna and the fourth slot antenna are formed closer to the center line as an arrival order of the microwaves is faster,
the first paired slot antenna is disposed in the first and second straight wave guides such that the microwaves reach the first paired slot antenna before the second paired slot antenna, and
the second paired slot antenna is disposed in the third and fourth straight wave guides such that the microwaves reach the second paired slot antenna before the first paired slot antenna.

31. The microwave range according to claim 27, wherein the wave guide includes a plurality of straight wave guides,
in at least one of the plurality of straight wave guides, a first straight section having a first height, a transition section having an inclined surface of which the height becomes lower, and a second straight section having a second height lower than the first height are connected to one another in a straight line, and the first straight section and the second straight section are spaced apart from each other by a length corresponding to ¼ of the wavelength of the microwaves in the waveguide.

32. The microwave range according to claim 27, wherein the wave guide comprises:
two straight wave guides sequentially disposed with a height difference; and
a bend configured to interconnect the two straight wave guides with the height difference,
wherein the bend has an inclined surface and is defined between a first boundary line at which the propagation direction of the microwaves is primarily bent at 45° in the first direction and a second boundary line at which the propagation direction of the microwaves is secondarily bent at 45° in the first direction, and
intersections between the center line of the width of the waveguide and the first and second boundary lines are spaced apart from each other by a distance corresponding to ¼ of the wavelength of the microwaves in the waveguide.

33. The microwave range according to claim 23, wherein the waveguide includes a first straight wave guide and a second straight wave guide facing each other,
a first paired slot antenna is formed on a bottom surface of the first straight wave guide, and
a second paired slot antenna is formed on a bottom surface of the second straight wave guide.

34. The microwave range according to claim 23, wherein, between the two slot antennas included in the one paired slot antenna, a slot antenna, which the microwaves reach first, is formed close to the center line of the width of the waveguide.

35. The microwave range according to claim 23, wherein each of the two slot antennas included in the one paired slot antenna includes rectangular through holes at both ends thereof and a connection through hole that connects the rectangular through holes to each other, has a width narrower than widths of the rectangular through holes, and is parallel to the major axis, and
resonance capacitance is adjusted by the width of the connection through hole.

36. The microwave range according to claim 33, wherein a perforated space of the two slot antennas is filled with a dielectric.
